(19) United States
(12) Patent Application Publication
(10) Pub. No.: US 2020/0356226 A1
(43) Pub. Date: Nov. 12, 2020

(54) ELECTRONIC APPARATUS AND DISPLAY METHOD FOR TOUCH PROXIMITY DETECTION

(71) Applicant: SONY CORPORATION, Tokyo (JP)

(72) Inventors: KENZO NISHIKAWA, TOKYO (JP); TAKASHI NUNOMAKI, KANAGAWA (JP); RYOKO AMANO, TOKYO (JP); LYO TAKAOKA, TOKYO (JP); RITSUKO KANO, TOKYO (JP); TOMOYA NARITA, KANAGAWA (JP); SHUNICHI KASAHARA, KANAGAWA (JP)

(21) Appl. No.: 16/941,982

(22) Filed: Jul. 29, 2020

Related U.S. Application Data
(63) Continuation of application No. 14/000,762, filed on Dec. 30, 2013.

(30) Foreign Application Priority Data
Feb. 28, 2011 (JP) 2011-042909

(51) Int. Cl. G06F 3/0482; G06F 3/0488; G06F 3/0481

(52) U.S. Cl. CPC G06F 3/0482; G06F 3/04817; G06F 3/0488; G06F 3/04886

(57) ABSTRACT

An apparatus includes an object approach determining unit and a display control unit. The object approach determining unit is configured to determine an approach of an object based on received data. The display control unit is configured to control a display to display a plurality of selectable icons. The display control unit is configured to control the display to change the display of the plurality of selectable icons to display only a portion of the plurality of selectable icons when the object approach determining unit determines that the object is close to the display.

### CROSS REFERENCE TO RELATED APPLICATIONS

The present application is a continuation application of U.S. patent application Ser. No. 14/000,762, filed on Dec. 30, 2013, which is a National Stage Entry of PCT/JP2012/001143 filed on Feb. 21, 2012, which claims priority from prior Japanese Patent Application 2011-042909 filed in the Japan Patent Office on Feb. 28, 2011, the entire contents of which are hereby incorporated by reference.

### TECHNICAL FIELD

The present disclosure relates to an electronic apparatus, a display method, and a program, and particularly, to an electronic apparatus, a display method, and a program appropriately used in the case where a user interface is displayed on the display unit on which the touch panel is laminated and provided.

### BACKGROUND ART

Conventionally, there are various types of electronic apparatuses configured to display a user interface for receiving an operation from a user on a display unit on which a touch panel is laminated. Specifically, the electronic apparatuses are applied to, for example, personal computers, smart phones, car navigation (car navigation) devices, ATMs (Automated teller machines), and the like.

In addition, the touch panel is able to not only detect the touch of a user's finger or the like but also detect the approach of the user's finger or the like (a capacitance type touch panel).

As a touch panel capable of detecting the approach of the user's finger or the like, for example, there is proposed a touch panel used in a car navigation apparatus and the like, and the touch panel normally displays a map on a screen and displays buttons for operation input at prescribed positions on the screen when the user's finger or the like approaches thereto (refer to Patent Document 1).

### CITATION LIST

### Patent Literature

[PTL 1] JP-A-2002-358162

### SUMMARY OF INVENTION

### Technical Problem

The electronic apparatus having the display unit, on which the touch panel is laminated, is able to easily change a user interface. For example, in a case of displaying plural buttons as options, it is possible to change the sizes of the buttons in accordance with the number of buttons which are simultaneously displayed.

However, when the number of buttons which are simultaneously displayed is large, the size of each button is reduced, and the spaces between the buttons are narrowed. In such a case, sometimes, there may be a problem with operability such as an erroneous operation which is caused when a user does not select (touch) a desired button.

The present disclosure has been made in view of the above situation, and has an object to improve the operability of the user interface which is formed by laminating the touch panel on the display unit.

### Solution to Problem

This invention broadly comprises an apparatus, a method, and a computer readable medium encoded with a program which causes a processor to perform the method. In one embodiment, an apparatus includes an object approach determining unit and a display control unit. The object approach determining unit is configured to determine an approach of an object based on received data. The display control unit is configured to control a display to display a plurality of selectable icons. The display control unit is configured to control the display to change the display of the plurality of selectable icons to display only a portion of the plurality of selectable icons when the object approach determining unit determines that the object is close to the display.

### Advantageous Effects of Invention

According to the aspect of the present disclosure, it is possible to improve operability of the user interface which is formed by laminating the touch panel on the display unit.

### BRIEF DESCRIPTION OF DRAWINGS

FIG. 1 is a block diagram illustrating an exemplary configuration of an electronic apparatus according to an embodiment.

FIG. 2 is a diagram illustrating functional blocks of a control section of FIG. 1.

FIG. 3 is a flowchart illustrating processing of adaptively displaying buttons.

FIGS. 4A, 4B, and 4C are diagrams illustrating a first display example of the processing of adaptively displaying buttons.

FIGS. 5A, 5B, and 5C are diagrams illustrating a second display example of the processing of adaptively displaying buttons.

FIGS. 6A, 6B, and 6C are diagrams illustrating a third display example of the processing of adaptively displaying buttons.

FIGS. 7A, 7B, and 7C are diagrams illustrating a fourth display example of the processing of adaptively displaying buttons.

### DESCRIPTION OF EMBODIMENTS

Hereinafter, best modes for carrying out the invention (hereinafter referred to as embodiments) will be described in detail with reference to the accompanying drawings.

### 1. Embodiment

Exemplary Configuration of Electronic Apparatus

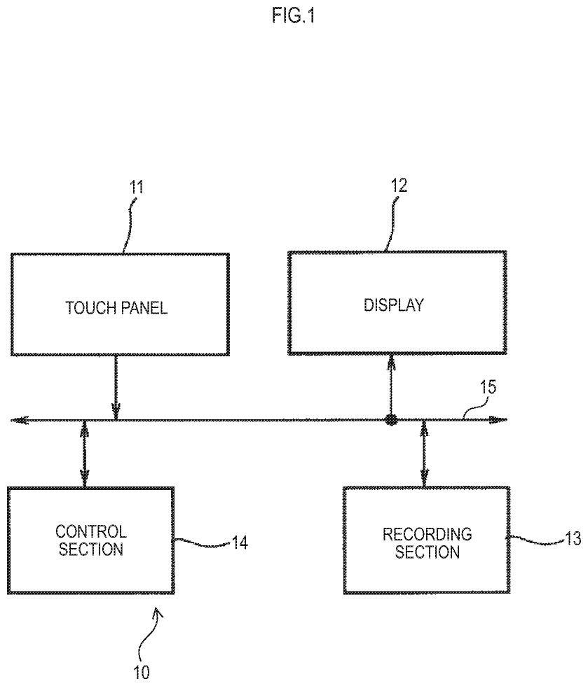

FIG. 1 is a block diagram illustrating an exemplary configuration of an electronic apparatus according to an embodiment. The electronic apparatus 10 has a user interface which is formed by laminating a touch panel on a display unit, and corresponds to, for example, a personal computer, a smart phone, a digital still camera, a digital video camera, a navigation apparatus, or the like. In addition, it is apparent that the invention can be applied to other electronic apparatuses.

The electronic apparatus 10 includes a touch panel 11 that is connected thereto through a bus 15, a display unit 12, a recording section 13, and a control section 14.

The touch panel 11 is able to transmit the screen display of the display unit 12 and detect not only the touch of the user's finger and the like but also the approach thereof (meaning that the finger approaches thereto up to a predetermined distance without touching thereon). Here, the user's finger or the like represents not only the user's finger but also another part of a body, a stylus (an indication stick having a pen shape) compatible with the touch panel 11, or the like. Hereafter, the user's finger or the like is simply referred to as the user's finger, but is defined to include another part of a body or a stylus.

As the touch panel 11, for example, a capacitance type may be employed. In addition, any type can be used if it is able to detect not only the touch of the user's finger but also the approach thereof. The touch panel 11 notifies detection information, which represents the detection result of the touch or the approach of the user's finger, to the control section 14 through the bus 15.

The display unit 12 is formed as, for example, an LCD, an organic EL display, or the like, and displays a screen image supplied from the control section 14 through the bus 15. The recording section 13 stores a program for control executed in the control section 14. Further, the recording section 13 stores various kinds of content (image data, audio data, video data, application programs, and the like) as processing targets of the corresponding electronic apparatus 10.

The control section 14 controls the entirety of the electronic apparatus 10 by executing the program for control stored in the recording section 13.

In addition to the above-mentioned configuration, the buttons, which are mechanically pressed, or the like may be provided as the user interface.

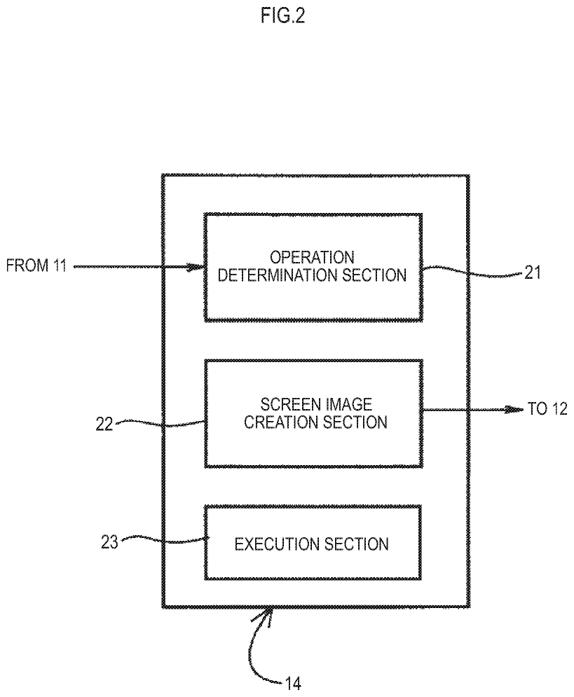

FIG. 2 shows functional blocks which are implemented in a way that the control section 14 executes the program for control.

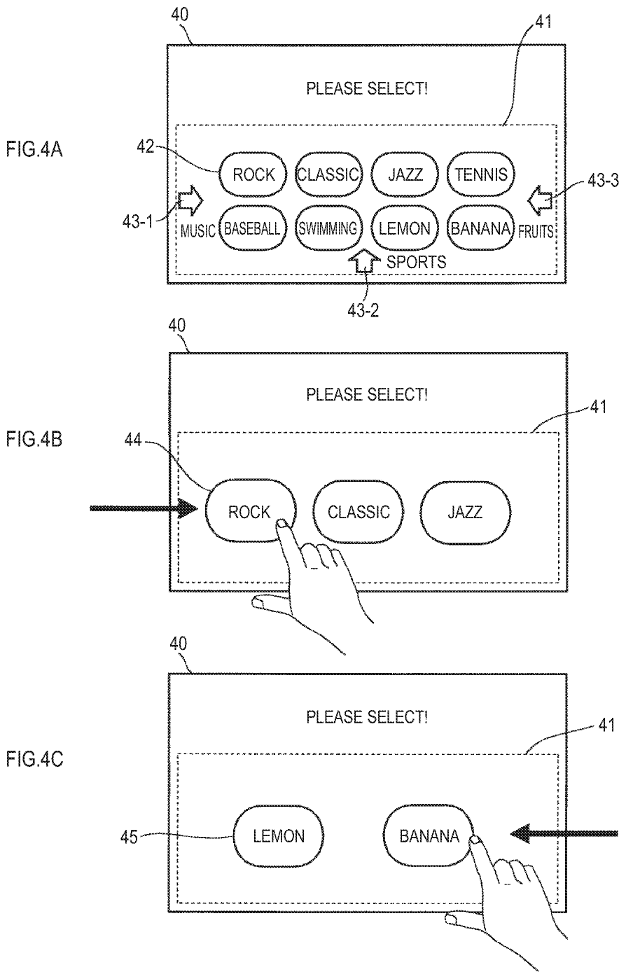

An operation determination section 21 determines user operation on the basis of the detection information sent from the touch panel 11. Specifically, on the basis of change in coordinates of the finger caused by the approach, the operation determination section may determine whether or not the finger enters into a selection area 41 (FIGS. 4A, 4B, and 4C) of the display unit 12, or may determine the direction of the approach or the locus of the movement. Further, the operation determination section may determine the coordinates of the touch.

The screen image generation section 22 generates an image (which includes buttons serving as the user interface and the like to be displayed on the display unit 12, and are hereinafter referred to as a screen image), and supplies the generated screen image to the display unit 12 through the bus 15. Further, the screen image generation section 22 changes the positions of the buttons on the screen image to positions, at which the user easily operates the buttons, in accordance with the determined user operation (the detailed description thereof will be given later in processing of adaptively displaying the buttons). An execution section 23 executes processing corresponding to the touched buttons.

Description of Operation

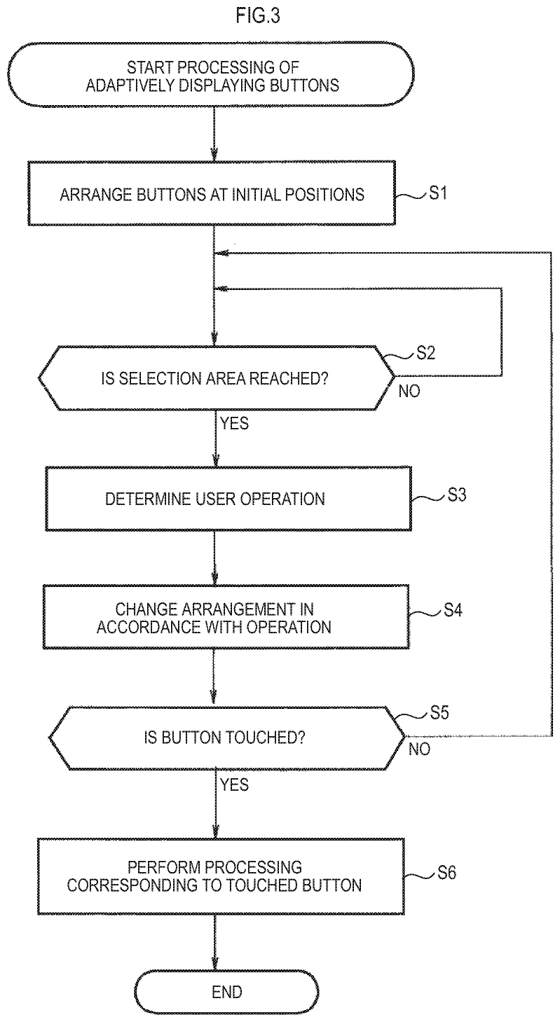

Next, the processing of adaptively displaying buttons performed by the electronic apparatus 10 will be described. FIG. 3 is a flowchart illustrating processing of adaptively displaying buttons performed by the electronic apparatus 10.

In step S1, the screen image generation section 22 generates a screen image in which the buttons as options of the user interface are arranged at initial positions, and supplies the screen image to the display unit 12 through the bus 15. The display unit 12 displays the supplies screen image.

In step S2, on the basis of the detection information sent from the touch panel 11, the operation determination section 21 determines whether or not the user's finger enters into the selection area including all the buttons displayed on the display unit 12 in a state where the finger is in close vicinity of the touch panel 11. Then, the operation determination section is on standby until it is determined that the finger enters into the area. When a user causes his finger to approach to the screen of the display unit 12, it is determined that the finger enters into the selection area, and then the processing advances to step S3.

In step S3, on the basis of the detection information sent from the touch panel 11, the operation determination section 21 determines the direction of the movement of the user's finger. In step S4, the screen image generation section 22 changes the arrangement of the buttons on the screen image in accordance with the direction of the movement of the user's finger which is determined by the operation determination section 21. That is, the screen image is updated, and is supplied to the display unit 12. Thereby, the arrangement of the buttons on the screen of the display unit 12 is changed.

In step S5, on the basis of the detection information sent from the touch panel 11, the operation determination section 21 determines whether or not the user's finger touches a button (actually, whether or not the finger touches the touch panel 11). If it is determined that the button is not touched, the processing returns to step S2, and repeats the processing therefrom.

If it is determined that the user's finger touched the button, the processing advances to step S6. In step S6, the operation determination section 21 detects the coordinates on the touch panel 11 at which the user's finger touches. The execution section 23 specifies the button touched by the user on the basis of the detected coordinates on the touch panel 11. Further, the execution section 23 performs the processing corresponding to the touched button. The processing of adaptively displaying buttons has hitherto been described.

Next, first to fourth specific display examples of the processing of adaptively displaying buttons will be described with reference to FIGS. 4A, 4B, 4C, 5A, 5B, 5C, 6A, 6B, 6C, 7A, 7B, and 7C.

FIGS. 4A, 4B, and 4C are diagrams illustrating the first display example of the processing of adaptively displaying buttons. In the first display example, the options are selected in accordance with the direction of the approach of the user's finger.

In the first step, for example, as shown in A of the drawing, plural buttons 42 respectively corresponding to the options are arranged on the screen 40 of the display unit 12. Further, arrows 43, which represent the directions of the approach of the user's finger, and categories, which serve as conditions for selecting options in accordance therewith, are displayed on the screen 40. In addition, the selection area 41 is invisible to the user, but may be configured to be visible.

In the case of A of the drawing, as the options, the buttons 42 are displayed, where the buttons respectively correspond to rock, classic, and jazz belonging to a music category, tennis, baseball, and swimming belonging to a sport category, and lemon and banana belonging to a fruit category. Further, the following are displayed: the arrow 43-1, which enters from the left side, and the text of music as the category corresponding thereto; the arrow 43-2, which enters from the lower side, and the text of sports as the category corresponding thereto; and the arrow 43-3, which enters from the right side, and the text of fruits as the category corresponding thereto.

For example, when a user moves his finger from the left side into the selection area 41 in a state where the finger is in close vicinity of the touch panel 11, as shown in B of the drawing, only the buttons 44, which correspond to the options belonging to the music category, on the screen 40 of the display unit 12 are changed. In such a case, only the buttons 44, which respectively correspond to rock, classic, and jazz belonging to the music category, are displayed by narrowing the options.

Further, for example, when a user moves his finger from the right side into the selection area 41 in a state where the finger is in close vicinity of the touch panel 11, as shown in C of the drawing, only the buttons 45, which correspond to the options belonging to the fruit category, on the screen 40 of the display unit 12 are changed. In such a case, only the buttons 45, which respectively correspond to a lemon and a banana belonging to the fruit category, are displayed by narrowing the options.

Furthermore, although not shown in the drawing, when a user moves his finger from the lower side into the selection area 41 in a state where the finger is in close vicinity of the touch panel 11, only the buttons, which correspond to tennis, baseball, and swimming belonging to the sport category, on the screen 40 of the display unit 12 are changed.

In addition, as shown in B or C of the drawing, the spaces and the sizes of the buttons 44 and 45 may be enlarged so as to be larger than those of the buttons 32 of A of the drawing.

According to the first display example shown in FIGS. 4A, 4B, and 4C, it is possible to reduce the number of displayed buttons in accordance with the direction of the approach of the user's finger, and thus this helps the user to easily press a button. Accordingly, it is possible to improve user operability.

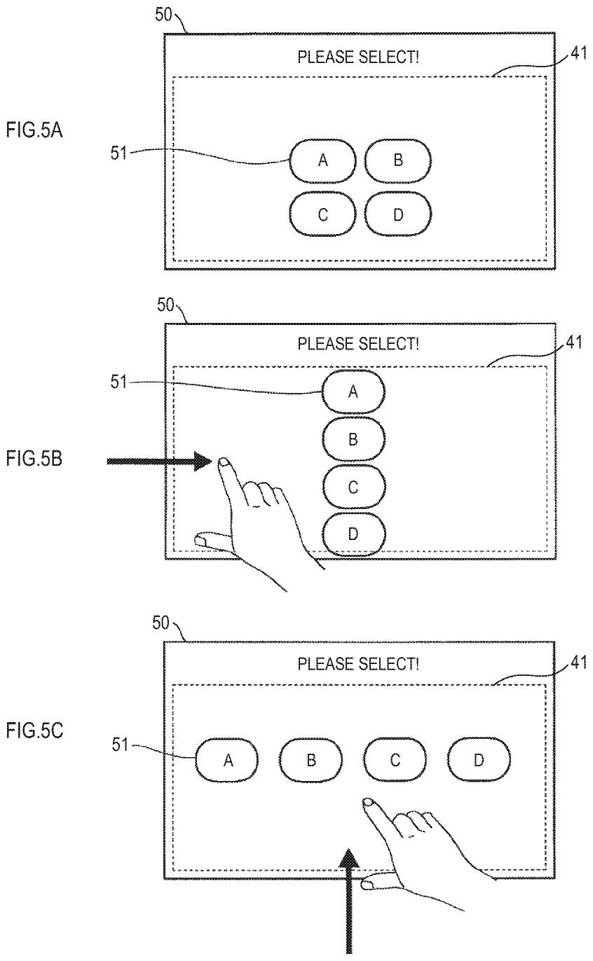

FIGS. 5A, 5B, and 5C show the second display example of the processing of adaptively displaying buttons. In the second display example, the direction of the arrangement of the buttons serving as the options is changed in accordance with the direction of the approach of the user's finger.

In the first step, for example, as shown in A of the drawing, plural buttons 51 respectively corresponding to the options are arranged in a matrix shape on the screen 50 of the display unit 12.

In the case of A of the drawing, the buttons 51 of A, B, C, and D respectively corresponding to the four options are arranged in a matrix shape of 2×2.

For example, when a user moves his finger from the left side into the selection area 41 in the state where the finger is in close vicinity of the touch panel 11, as shown in B of the drawing, the arrangement of the plural buttons 51 on the screen 50 is changed in a direction perpendicular to the direction of the approach, that is, the vertical direction. In addition, it is the same for the case where a user moves his finger from the right side into the selection area 41 in the state where the finger is in close vicinity of the touch panel 11.

Further, for example, when a user moves his finger from the lower side into the selection area 41 in the state where the finger is in close vicinity of the touch panel 11, as shown in C of the drawing, the arrangement of the plural buttons 51 on the screen 50 is changed in a direction perpendicular to the direction of the approach, that is, the horizontal direction. In addition, it is the same for the case where a user moves his finger from the upper side into the selection area 41 in the state where the finger is in close vicinity of the touch panel 11.

According to the second display example shown in FIGS. 5A, 5B, and 5C, the direction of the arrangement of the buttons is changed to be perpendicular to the direction of the approach of the user's finger, and thus this helps the user to easily press a button as compared with the case where the buttons are arranged in the matrix shape. Accordingly, it is possible to improve user operability.

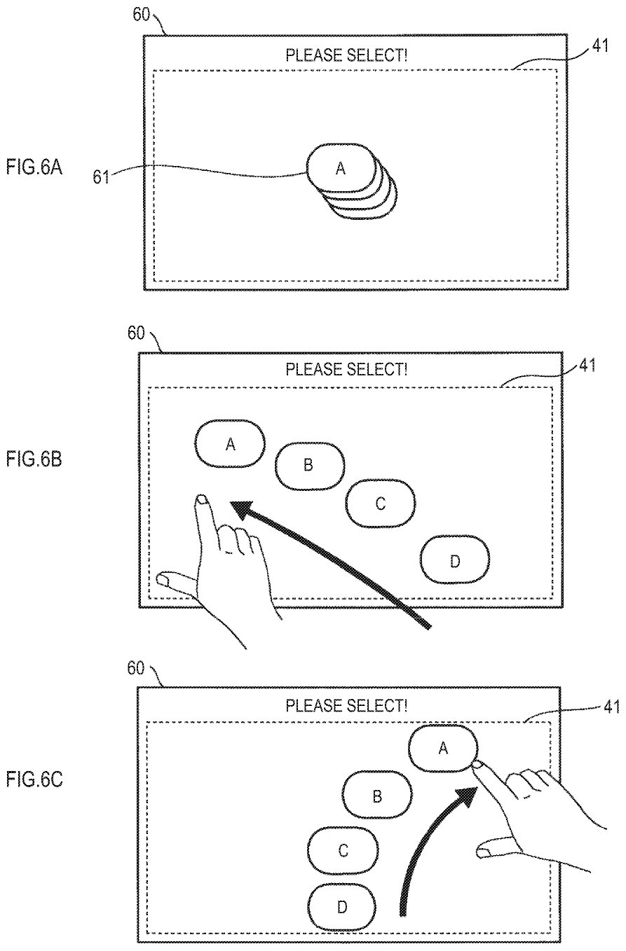

FIGS. 6A, 6B, and 6C show the third display example of the processing of adaptively displaying buttons. In the third display example, the direction of the arrangement of the buttons serving as the options is changed in accordance with the locus of the movement of the user's finger.

At the first step, for example, as shown in A of the drawing, plural buttons 61 respectively corresponding to the options are arranged to overlap one another on the screen 60 of the display unit 12.

In the case of A of the drawing, the buttons 61 of A, B, C, and D respectively corresponding to the four options are arranged to overlap one another.

For example, when a user moves his finger from the lower right side to the upper left side in the selection area 41 in the state where the finger is in close vicinity of the touch panel 11, as shown in B of the drawing, the arrangement of the plural buttons 61 on the screen 60 is changed in accordance with the locus of the movement.

Likewise, when a user moves his finger from the lower middle side to the upper right side in the selection area 41 in the state where the finger is in close vicinity of the touch panel 11, as shown in C of the drawing, the arrangement of the plural buttons 61 on the screen 60 is changed in accordance with the locus of the movement.

According to the third display example shown in FIGS. 6A, 6B, and 6C, the user is able to arbitrarily change the arrangement of the buttons by moving his finger, and thus this helps the user to easily press a button. Accordingly, it is possible to improve user operability.

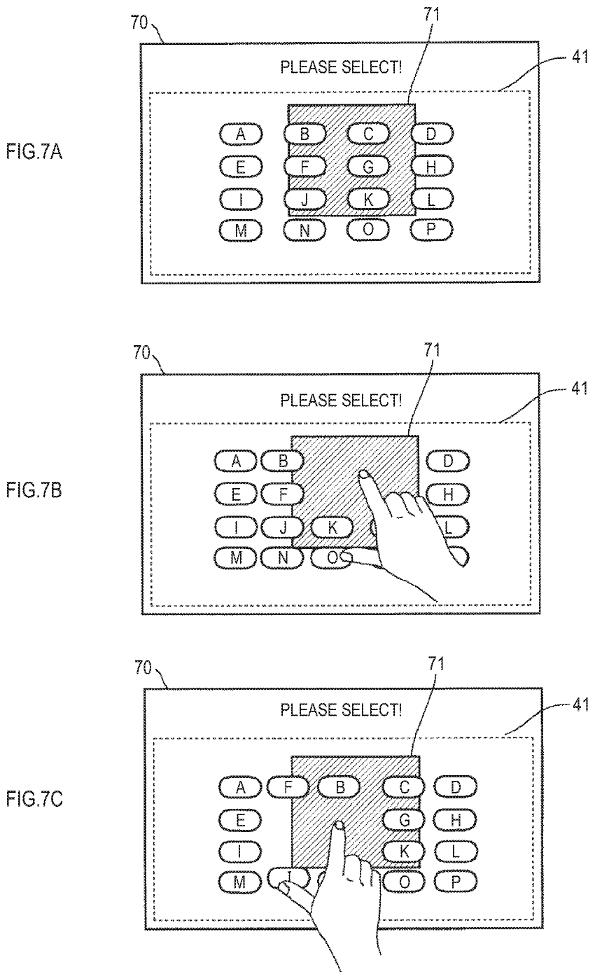

FIGS. 7A, 7B, and 7C show the fourth display example of the processing of adaptively displaying buttons. In the fourth display example, the direction of the arrangement of the buttons serving as the options is changed in accordance with the direction of the approach of the user's finger.

At the first step, for example, as shown in A of the drawing, plural buttons 72 respectively corresponding to the options are arranged in a matrix shape so as to overlap with the background image on the screen 70 of the display unit 12.

In the case of A of the drawing, the background includes an object 71, and the buttons 72 of A to P are arranged in a matrix shape of 4×4 so as to overlap with the object 71.

For example, when a user causes his finger to approach to the object 71, as shown in B or C of the drawing, the arrangement of the plural buttons 72 on the screen 70 is changed to avoid the finger.

According to the fourth display example shown in FIGS. 7A, 7B, and 7C, the user is able to clear away the displayed buttons by moving his finger. Accordingly, it is possible to make the background object 71 easily visible. Further, it is possible to press a button after verifying the object 71. Accordingly, it is possible to improve user operability.

However, the series of the above-mentioned processing may be executed by hardware, and may be executed by software.

In addition, the program executed by the computer may be a program which chronologically performs the processing in order of description of the present specification, and may be a program which performs the processing in parallel or at necessary timing such as the timing of calling.

Further, the program may be processed by a single computer, and may be distributively processed by plural computers. Furthermore, the program may be transmitted to a remote computer, and may be executed therein.

In addition, the embodiment of the present disclosure is not limited to the above-mentioned embodiments, and may be modified into various forms without departing from the technical scope of the invention.

It should be noted that the present disclosure can also take the following configurations.

[1] An electronic apparatus comprising:
a generation section that generates an operation screen which includes buttons respectively corresponding to a plurality of options selectable by a user;
a display section that displays the generated operation screen; and
a detection section that detects an approach of an instruction section of the user to the display section,
wherein the generation section changes arrangement of the buttons on the operation screen, on the basis of a position of the detected approach of the instruction section.

[2] The electronic apparatus according to claim 1, wherein the generation section changes the arrangement of the buttons on the operation screen, on the basis of a locus or a direction of movement of the position of the detected approach of the instruction section.

[3] The electronic apparatus according to claim 2, wherein the generation section selects a plurality of buttons on the operation screen in accordance with the direction of the movement of the position of the detected approach of the instruction section.

[4] The electronic apparatus according to claim 3, wherein the generation section generates the operation screen including information in which a selection condition for selecting the plurality of buttons is associated with the direction of the movement of the position of the approach of the instruction section.

[5] The electronic apparatus according to claim 2, wherein the generation section changes the arrangement of the plurality of buttons on the operation screen in a direction perpendicular to the direction of the movement of the position of the detected approach of the instruction section.

[6] The electronic apparatus according to claim 2, wherein the generation section changes the arrangement of the buttons on the operation screen in accordance with the locus of the movement, on the basis of the locus of the movement of the position of the detected approach of the instruction section.

[7] The electronic apparatus according to claim 1, wherein the generation section changes the arrangement of the buttons on the operation screen so as to avoid the position of the detected approach of the instruction section.

[8] The electronic apparatus according to claim 1, wherein the detection section is laminated on the display section, and transmits the operation screen, which is displayed on the display section, so as to thereby display the generated operation screen.

[9] A method of controlling display of an electronic apparatus having
a generation section that generates an operation screen,
a display section that displays the generated operation screen, and
a detection section that detects approach of an instruction section of a user to the display section,
   the method comprising allowing the generation section to:
   generate the operation screen which includes buttons respectively corresponding to a plurality of options selectable by the user; and
   change arrangement of the buttons on the operation screen, on the basis of a position of the detected approach of the instruction section.

[10] A program for a computer, which includes
a display section that displays a generated operation screen, and
a detection section that detects approach of an instruction section of a user to the display section,
   the program causing the computer to execute processing comprising:
   a generation step of generating the operation screen which includes buttons respectively corresponding to a plurality of options selectable by the user; and
   a change step of changing arrangement of the buttons on the operation screen, on the basis of a position of the detected approach of the instruction section.

1. An apparatus, comprising:
circuitry configured to:
receive data from a touch panel;
control a display screen to display a plurality of icons;
determine, based on the received data, a locus of a movement of an object; and
change, on the display screen, a display arrangement of the plurality of icons based on the locus of the movement of the object, wherein the locus of the movement of the object is associated with a direction of the movement of the object.

2. The apparatus according to claim 1, wherein the circuitry is further configured to:
determine the object is in proximity to the display screen such that the display screen is untouched by the object; and
change the display arrangement of the plurality of icons based on the determination that the object is in proximity to the display screen.

3. The apparatus according to claim 2, wherein the circuitry is further configured to:
determine that the object passes along a path; and
change the display arrangement of the plurality of icons along the path of the object based on the determination that the object passes along the path.

4. A method, comprising:
receiving data from a touch panel;
controlling a display screen of an apparatus to display a plurality of icons;
determining, based on the received data, a locus of a movement of an object; and
changing a display arrangement of the plurality of icons on the display screen based on the locus of the movement of the object, wherein the locus of the movement of the object is associated with a direction of the movement of the object.

5. A non-transitory computer-readable medium having stored thereon computer-executable instructions, which when executed by an apparatus, cause the apparatus to execute operations, the operations comprising:
receiving data from a touch panel;
displaying a plurality of icons on a display screen;
determining, based on the received data, a locus of a movement of an object; and
changing a display arrangement of the plurality of icons on the display screen based on the locus of the movement of the object, wherein the locus of the movement of the object is associated with a direction of the movement of the object.

6. The apparatus according to claim 3, wherein the path of the object corresponds to the direction of the movement of the object.

7. The apparatus according to claim 1, wherein the display arrangement of the plurality of icons corresponds to an overlapping display arrangement of the plurality of icons.

8. The apparatus according to claim 7, wherein
a first icon of the plurality of icons overlaps a second icon of the plurality of icons based on the display arrangement, and
the second icon of the plurality of icons overlaps a third icon of the plurality of icons based on the display arrangement.

9. The apparatus according to claim 8, wherein
the circuitry is further configured to control the display arrangement of the third icon, the second icon, and the first icon from a middle of a lower side of the display screen to an upper portion of a right side of the display screen, based on the locus of the movement of the object from the middle of the lower side of the display screen to the upper portion of the right side of the display screen.

10. The apparatus according to claim 8, wherein
the circuitry is further configured to control the display arrangement of the third icon, the second icon, and the first icon from a right portion of a lower side of the display screen to an upper portion of a left side of the display screen, based on the locus of the movement of the object from the right portion of the lower side of the display screen to the upper portion of the left side of the display screen.

11. The apparatus according to claim 8, wherein
the first icon overlaps the second icon in an overlapping order, and
the circuitry is further configured to determine a specific order of the display arrangement of the plurality of icons based on the overlapping order.

12. The apparatus according to claim 1, wherein
a first icon of the plurality of icons is below a second icon of the plurality of icons in an overlapping state of the plurality of icons,
the circuitry is further configured to change the display arrangement of the plurality of icons in a specific order in a non-overlapping state of the plurality of icons, and
the display arrangement of the plurality of icons in the specific order includes the second icon after the first icon from a lower side of the display screen to an upper side of the display screen.
